(19) United States
(12) Patent Application Publication
(10) Pub. No.: US 2009/0141038 A1
(43) Pub. Date: Jun. 4, 2009

(54) Bezier Curves for Low Memory Embedded Graphics Systems

(76) Inventors: Saket Prashant NEWASKAR, Bangalore (IN); Ravi VERMA, Bangalore (IN)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/263,838

(22) Filed: Nov. 3, 2008

(30) Foreign Application Priority Data
Nov. 2, 2007 (IN) 2494/CHE/2007

(51) Int. Cl. G09G 5/02; G06T 11/20

(52) U.S. Cl. 345/589; 345/442

(57) ABSTRACT

A method and system for determining a number of samples used in rendering a Bezier curve, defined by first, second, third and fourth sequential Bezier control points. The method and system determines: a visual significance of a curve by measuring a characteristic of the curve, a curvature estimation factor of the curve based on a length of the curve and a distance between first and last control points of the curve, and the number of samples for a predetermined accuracy depending on the visual significance of the curve and the curvature estimation factor.

### CROSS-REFERENCE TO RELATED APPLICATIONS

This application is based upon and claims the benefit of priority from the prior Indian Patent Application No. 2494/CHE/2007, filed Nov. 2, 2007, the entire contents of which are incorporated herein by reference.

### BACKGROUND OF THE INVENTION

1. Field of the Invention

The present invention relates to the field of vector graphics. More particularly, the invention relates to the field of Bezier curves and other curves.

2. Discussion of the Related Art

In low memory embedded graphics system implementations, a Bezier curve is rendered or processed as consecutive lines between discrete samples on the curve. The quality of the curve being rendered is directly related to the number of samples taken into consideration. However, a large number of samples for most curves are redundant and also consume a large amount of CPU cycles. The method described herein attempts to solve this problem by introducing the concept of visual significance and deciding the number of samples in a curve based on its visual significance. In one embodiment, visual significance is determined using the curvature of a curve and the area of the curve.

Prior art in this field has dealt with an adaptive approach of sampling Bezier curves. Such approaches (adaptive subdivision algorithms) give very good results. However in a case of low memory & low computation power embedded systems, these approaches are not recommended because of their recursive nature. (Recursive nature of adaptive subdivision introduces the risk of stack overflow in embedded systems). Also, for graphics operations like filling, it is imperative that these samples are stored. To store these samples allocation of memory is necessary.

If an adaptive approach is used, dynamic allocation of memory for every point generated will be necessary. This is not recommended since it would be a very slow process. Thus, memory should be allocated before calculation of curve points, and for this the number of points required for a curve should be known. Thus, number of samples should be predicted and then memory should be allocated.

Prior art in this field has not considered the visual significance of a curve. A curve which is large and occupies more of a display region is visually more significant as compared to a curve which is small. Thus, a curve which is visually more significant will be sampled in more detail. Also, color of the curve would contribute to its visual significance. Previous art in this area has not considered this approach objectively.

The current invention makes use of visual significance to reduce the CPU & memory usage depending on the visual significance of a curve. As this approach avoids use of recursive methods to sample the curve, it significantly reduces the usage of stack which is critical in low memory systems.

To find the number of samples by which a curve can be accurately described in terms of lines between these samples is a problem. The fact that for a curve to be smooth and accurate, more samples taken at the curvature should be taken into consideration. Thus, the sampling rate along the curve should be variable. On the other hand, this would be a computationally complex affair. Also, such a method would demand a large memory for which the calculation of an upper limit would be difficult. Samples are to be stored for processing in a case of operations such as filling. Thus, it is necessary to know the number of samples in a curve before calculation of the curve samples. Thus, algorithms, like adaptive subdivision, which use continuous subdivision to generate points on the curve, are not suitable algorithms since the number of points generated by these algorithms for a curve is not predictable and dynamic memory allocation would be required for every sample generated. Also, such algorithms are recursive. Recursive algorithms are not recommended for embedded systems because of stack constraints.

### SUMMARY OF THE INVENTION

An object of this invention is to utilize the visual significance of a curve in deciding the number of samples by which a curve can be satisfactorily described in terms of lines between these samples.

Another object of this invention is to utilize the visual significance of a curve in deciding amount of memory & CPU cycles to spend on generating the points on a curve or for filling a curve.

According to one aspect of the invention, a method is provided to determine a number of samples used in rendering a Bezier curve, defined by first, second, third and fourth sequential Bezier control points. The method includes determining a visual significance of a curve by measuring a characteristic of the curve, determining a curvature estimation factor of the curve based on a length of the curve and a distance between first and last control points of the curve, and determining the number of samples for a predetermined accuracy depending on the visual significance of the curve and the curvature estimation factor.

According to another aspect of the invention, a system is provided to determine the number of samples used in rendering a Bezier curve, defined by first, second, third and fourth sequential Bezier control points. The system includes a host processor, an embedded memory, a graphics processor unit (GPU), and a PCI bus. The GPU includes a graphics controller and an application programming interface (API). The graphics controller is configured to determine a visual significance of a curve by measuring a characteristic of the curve, a curvature estimation factor of the curve based on a length of the curve and a distance between first and last control points of the curve, and a number of samples for a predetermined accuracy depending on the visual significance of the curve and the curvature estimation factor.

According to another aspect of the invention, a computer readable storage medium is provided which is encoded with computer executable instructions, which when executed by a computer, cause the computer to perform a method to determine a number of samples used in rendering a Bezier curve, defined by first, second, third and fourth sequential Bezier control points. The method includes determining a visual significance of a curve by measuring a characteristic of the curve, determining a curvature estimation factor of the curve based on a length of the curve and a distance between first and last control points of the curve, and determining the number of samples for a predetermined accuracy depending on the visual significance of the curve and the curvature estimation factor.

According to another aspect of the invention, a method, system, and computer readable storage medium are provided, where the determining the visual significance of the curve includes determining a bounding box defined by the four control points defining the Bezier curve, and calculating an area of the bounding box as the visual significance.

According to another aspect of the invention, a method, system, and computer readable storage medium are provided, where the determining the visual significance of the curve includes calculating a perimeter of the curve (L) as the sum of distances given by: a distance between a start point and the first control point, a distance between the first control point and the second control point, and a distance between the second control point and an end point; and using the perimeter of the curve as the visual significance.

According to another aspect of the invention, a method, system, and computer readable storage medium are provided, where the determining the visual significance of the curve includes determining a background color, determining a color of the curve, comparing the background color with the color of the curve, and determining the number of samples depending on a color contrast between the curve and the background.

According to another aspect of the invention, a method, system, and computer readable storage medium are provided, where the determining the curvature estimation factor of the curve includes calculating the perimeter of the curve (L) as the sum of the distances given by: a distance between the first control point and the second control point, a distance between the second control point and the third control point, and a distance between the third control point and the fourth control point; calculating a distance (r) between a start point and an end point; and calculating the curvature estimation factor f by using f=(L−r)/L.

According to another aspect of the invention, a method, system, and computer readable storage medium are provided, where the determining the curvature estimation factor of the curve includes calculating perimeter of the curve (L) as a sum of distances given by: a distance between the first control point and the second control point, a distance between the second control point and the third control point, and a distance between the third control point and the fourth control point; calculating a distance (r) between a start point and an end point; calculating an intermediate curvature estimation factor e by using e=(L−r)/L; and calculating the curvature estimation factor f depending on a tolerance t as f={x: x is the greater of e and t}.

According to another aspect of the invention, a method, system, and computer readable storage medium are provided, where the determining the curvature estimation factor includes setting the curvature estimation factor to a fixed value which depends on the predetermined accuracy.

According to another aspect of the invention, a method, system, and computer readable storage medium are provided, where the determining the number of samples includes, determining a maximum number of samples based on the visual significance depending on the predetermined accuracy; and determining the number of samples is determined by multiplying the maximum number of sample points by the curvature estimation factor.

According to another aspect of the invention, a method, system, and computer readable storage medium are provided, wherein the determining the number of samples includes using a predetermined mapping of visual significance ranges to a number of sample points.

Further objects, features and advantages will become apparent from the following description, claims and drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows the overall system architecture according to an embodiment of the invention;

FIG. 2 shows an example of a cubic Bezier curve and its control points;

FIG. 3 shows the flow chart for an example method for generating Bezier curves according to an embodiment of the invention.

FIG. 4 shows a Bezier curve rendered and the sample points used in generating the curve according to an embodiment of the invention;

FIG. 5 shows the Bezier curve rendered with lesser sample points according to an embodiment of the invention;

FIG. 6 shows the Bezier curve rendered with different sample points for different sizes of the curves according to an embodiment of the invention;

FIG. 7 shows sets of two Bezier curves of different curvature estimation factors rendered using large and small number of sample points according to an embodiment of the invention;

FIG. 8 shows the method of determining the number of sample points required for a given Bezier curve specified by its 4 control points using the bounding box area to determine the visual significance according to an embodiment of the invention;

FIG. 9 shows the method of determining the number of sample points required for a given Bezier curve specified by its 4 control points using the perimeter of the curve to determine the visual significance according to an embodiment of the invention; and

FIG. 10 shows experimental results for a method conducted according to an embodiment of the invention.

### DETAILED DESCRIPTION OF THE INVENTION

Bezier curves have a special significance with respect to vector graphics applications. Bezier curves of order two and three, i.e. quadratic and cubic Bezier curves, are generally used as basic units in these applications. Higher order curves can be represented as a combination of cubic and quadratic curves. Thus, here cubic Bezier curves are considered. However, the method described here is applicable to all types of curves or geometric equations such as an ellipse, circle, arcs etc., for which calculation of length or bounding box area is possible.

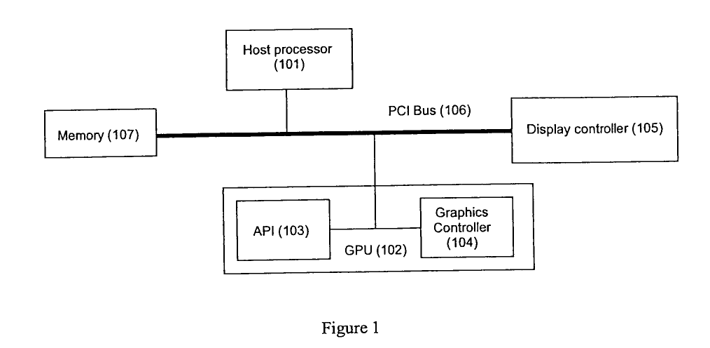

Referring to FIG. 1, the hardware implementation of this invention is shown. The host processor (101) runs two dimensional graphical applications such as a flash player and SVG player. The Graphics Processor Unit (GPU) (102) contains the graphics controller (104), Application Programming Interface (API) (103), etc. The invention is embedded in a memory (107), where the memory may be a flash memory, Read Only Memory (ROM) or Random Access memory (RAM). The API (103) supports requests made to the GPU (102) by the host processor (101). The host processor (101) requests the API (103) of the GPU (102) to perform a graphical operation through a communication mechanism like the PCI bus (106). The embedded application being loaded onto the GPU at the time of execution of the application. The embedded invention makes use of the embedded memory (107). The embedded memory also functions as cache memory for temporary storage during the performance of tasks. Using the hardware accelerator, i.e. the graphics controller, implements the application for deciding the number of sampling points of the Bezier curve and rendering the curve.

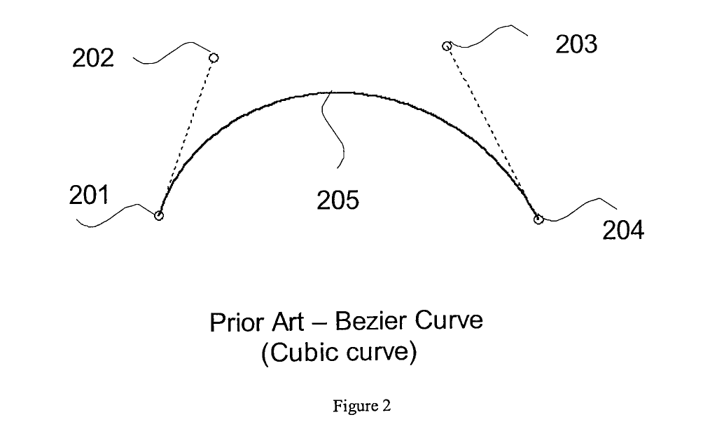

A cubic Bezier curve can be described completely using four Bezier control points as shown in FIG. 2. The first control point (201) is also the start point of the curve. The last control point (204) is also the end point of the curve. The middle two control points (202 and 203) are also shown in the figure. The Bezier curve defined by these points (205) is completely contained within the bounding box defined by these control points.

Bezier curves can be described by parametric equations. The parametric equation for a cubic Bezier curve will be as follows:

x(t)=x₀*(1−t)³+x₁*(1−t)²*t+x₂*(1−t)*t²+x₃*t³

y(t)=y₀*(1−t)³+y₁*(1−t)²*t+y₂*(1−t)*t²+y₃*t³

where t varies from 0 to 1. The number of discrete sample points on the curve will be the number of steps in which t changes from 0 to 1.

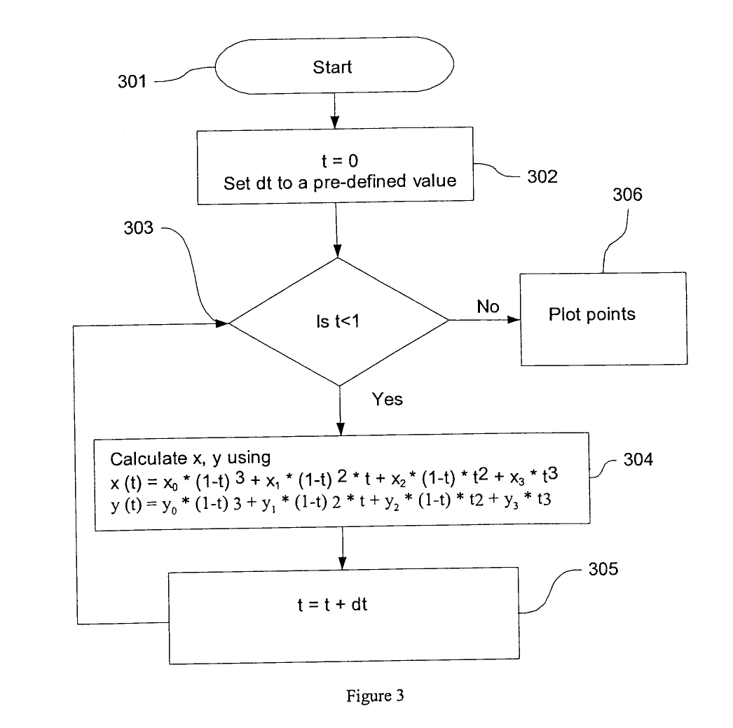

The method of generating a curve based on the above equation is described in the flowchart given in FIG. 3. Here, we define a number of sample points and set dt to a predefined value (302). The predefined value is defined as the reciprocal of the number of samples. Then we repeat the process of finding the points defined by a pair (x, y), by substituting the value of t is the above equations (304). We then increment t by dt (305). This is repeated until t exceeds 1 (303).

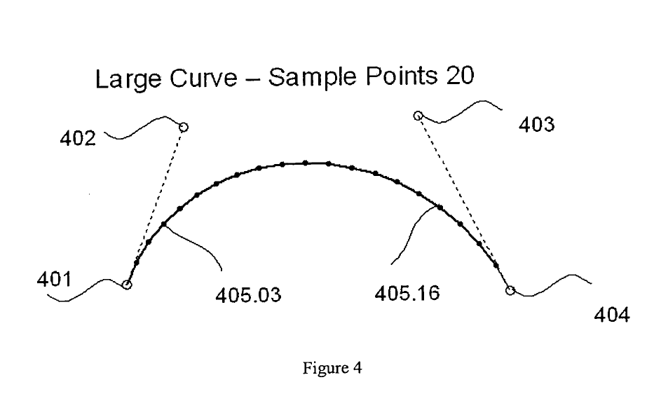

The curve defined by FIG. 2 is plotted using this method and the result is shown in FIG. 4. The control points for this curve are shown by 401, 402, 403 and 404. Here we used 20 sample points in generating the curve. For example 405.03 shows the third sample point and 405.16 shows the sixteenth sample point.

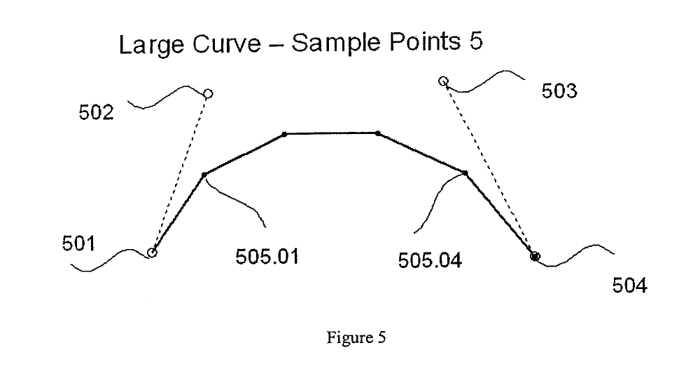

FIG. 5 shows the same curve rendered using only 5 sample points. Here the control points for this curve are shown using 501, 502, 503 and 504. 505.01 shows the first sample point and 505.04 shows the fourth sample point. As we can see the curve is not very smooth here as the number of sample points is less.

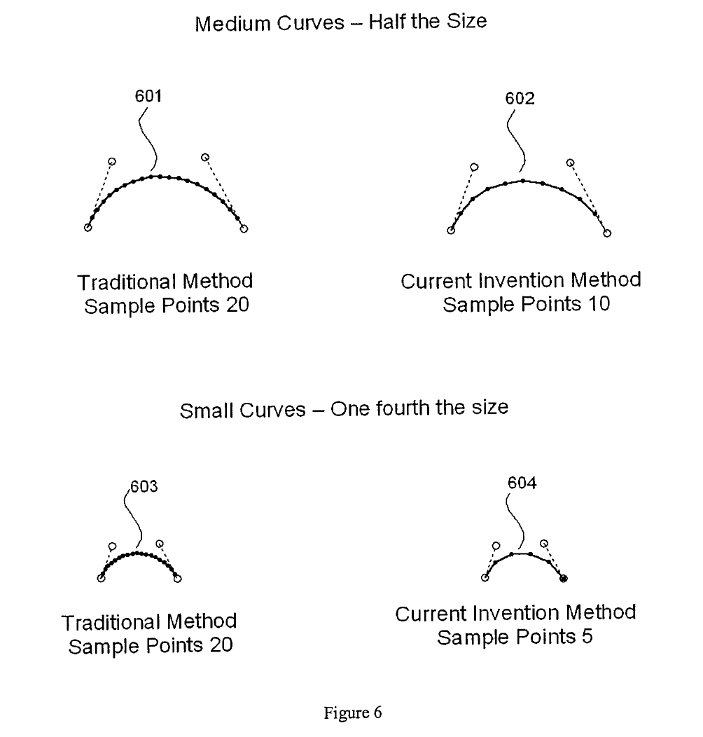

FIG. 6 shows the same curve rendered at lesser sizes. 601 and 602 show the curve rendered at half the size of the curve of FIG. 5. In 601, the curve is rendered using 20 sample points and in 602 it is rendered using 10 points. 603 and 604 show the curve rendered at quarter the size of the curve of FIG. 4. In 603, the curve is rendered using 20 sample points and in 604 it is rendered using 5 points. In 604 although we are using less sample points for the same curve, the smoothness of the curve is not affected much because of the smaller size of the curve.

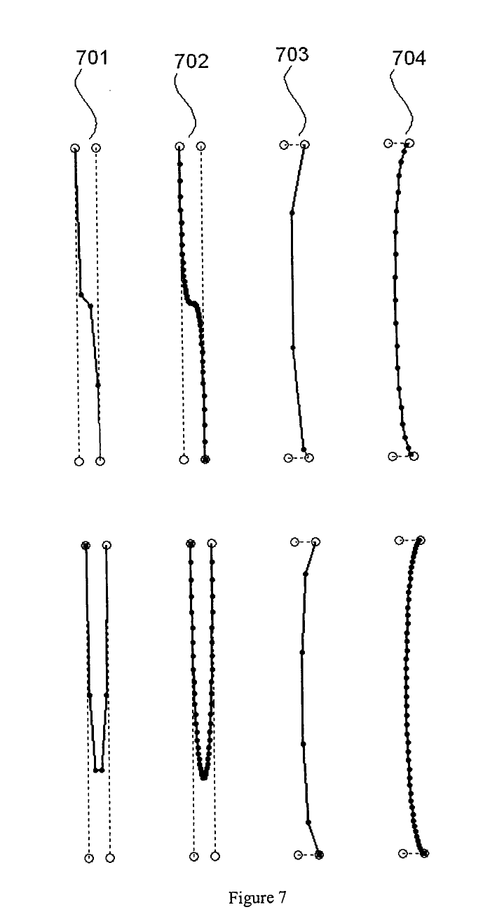

FIG. 7 shows curves of different curvature drawn with a small and large number of sample points. 701 and 702 show a curve with a large curvature. 703 and 704 show a curve with small curvature. When we use lesser sample points for the curves (701, 703), the appearance of the curve with a larger curvature (701) is more deviant from its expected appearance (702). The curve with lesser curvature (703) is closer in appearance to the expected appearance (704).

The concept of visual significance can be correlated to the concept of frequency filtering in case of image processing. In image processing, for data compression, very high frequencies are filtered out since they have a small or negligible effect on the quality of the image with respect to the human eye. Similarly variations in cases of small curves on a display would represent very high frequencies. Thus, the smaller the curve, the more visually insignificant are the variations in the curve. Also it is difficult for the human eye to pinpoint variations in a small curve as compared to variations in a larger curve. This leads us to a conclusion that smaller curves can have a lesser number of samples as compared to a larger curve.

The color of a curve relative to its background would also contribute to its visual significance. A curve having more variation in color with respect to its background will be more visually significant. If the background has got dull color and the Bezier curve has prominent color, the number of samples has to be large. In the reverse situation, where the background has got prominent color and the curve has got dull color, then the number of samples can be reduced accordingly.

On these basic assumptions, a larger curve which is visually more significant can be sampled in more detail as compared to a smaller curve. Existing methods for rendering Bezier curves use the same number of samples without considering the visual significance of a curve. This invention gives a method for using the visual significance defined by the size of the curve and its color, in combination with the curvature of the curve to determine the number of samples required for a given Bezier curve.

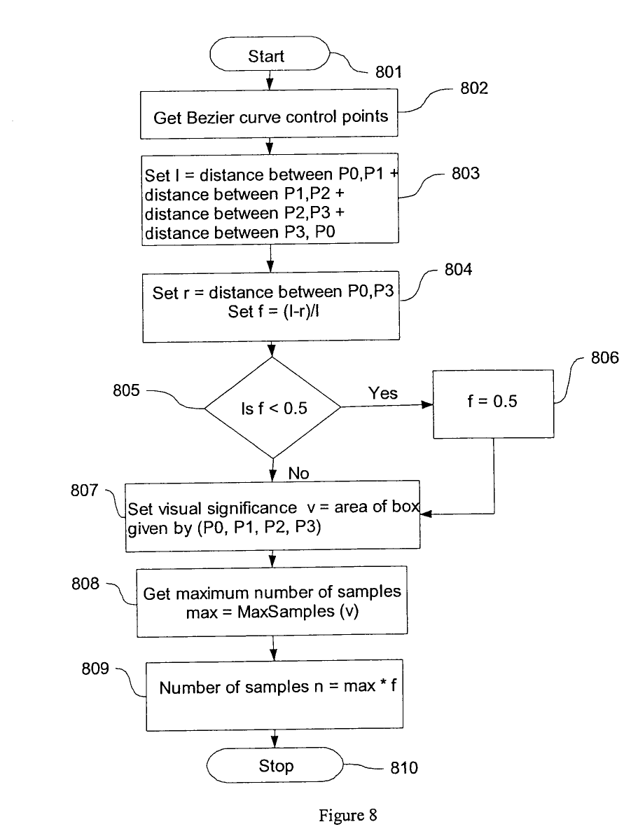

FIG. 8 describes the method for calculating the number of samples required for a curve that is defined by four control points. In the first step (802), the Bezier control points P0, P1, P2 and P3 are located. The perimeter of the quadrilateral (L) formed by the control points is calculated (803), which denotes the approximate length of the curve. Here, “r” is set as the distance between P0 and P3 (804), i.e., the distance between the start point and the end point of the curve. If a straight line is to be drawn between the two end points of the curve, approximately r pixels are required. The curvature estimation factor, f is calculated using the following formula,

f=(L−r)/L.

Here, f gives a good estimation of the curvature of the curve. The greater the value of f, the greater the curvature of the curve. For values of f lower than 0.5, the curve is more linear. The flattest curve is a straight line, and for a straight line, the curve estimation factor would be very close to zero. It is checked if f<0.5 (805). If f<0.5, then f is assigned a value of 0.5 (806). For a value of f≧0.5, the approximate area of the bounding box defined by the points P0, P1, P2 and P3 are denoted by “v” (807). Depending on the application and the quality required by the user, the maximum number of samples for a range of areas can be set. To set the maximum number of samples required for a particular area, the display area is divided into various ranges of areas. For example, the ranges might be from 0-32, 33-256, 257-1024, 1025-4096, 4097-32768 and so on as shown in Table 1 below. Then, the maximum number of samples that should be taken for a particular range of areas is decided.

TABLE 1

| v | max |
|---|---|
| 0-32 | 8 |
| 33-256 | 16 |
| 257-1024 | 24 |
| 1025-4096 | 32 |
| 4097-32768 | 48 |

This is a trial and error process and is similar to tuning a system to suit a certain specific purpose. Generally, the curves belonging to a higher range of v, i.e., curves having higher visual significance will have more samples. Using the calculated value of v, the maximum number of samples (max) is obtained (808). The number of samples required for the curve can be obtained by multiplying the maximum number of samples (max) with the curvature estimation factor (f) (809).

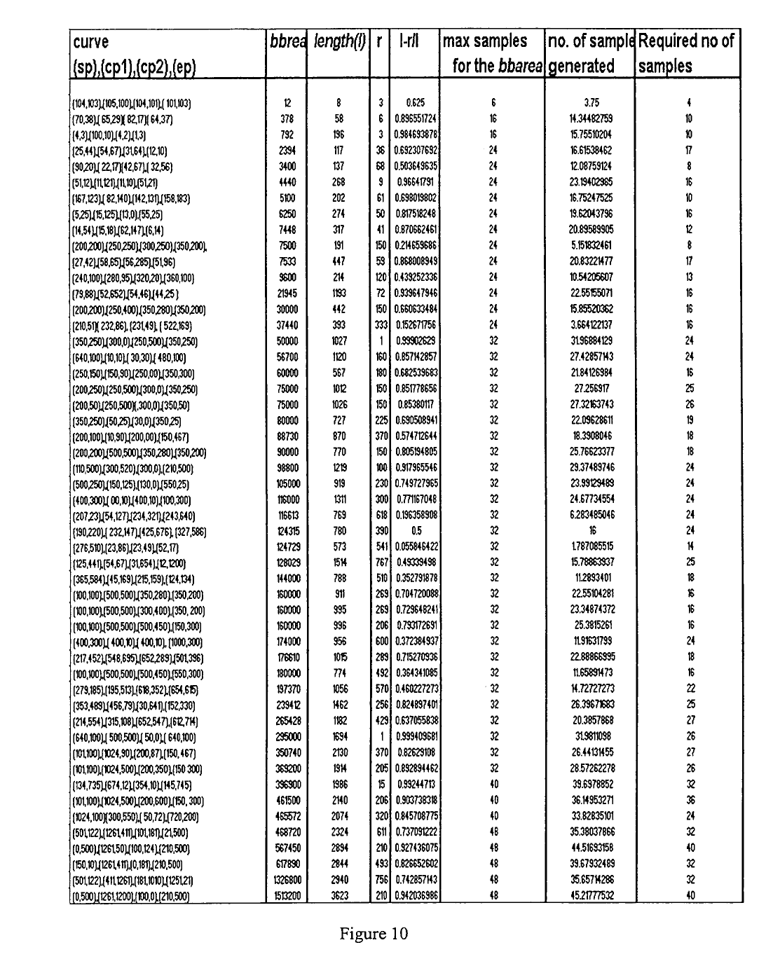

Experiments were conducted to verify the method mentioned above. A set of 50 cubic Bezier curves drawn with black color on a white background were taken for these experiments. Each curve was initially plotted with 256 points to get a good view of the shape of the curve. Then the minimum number of samples required to represent the shape of the curve was found. This number would be a relative value varying from person to person. However, approximately the value would be the same. This number was compared with the number of samples generated by the above method. The data shown in FIG. 10 has been generated based on these experiments.

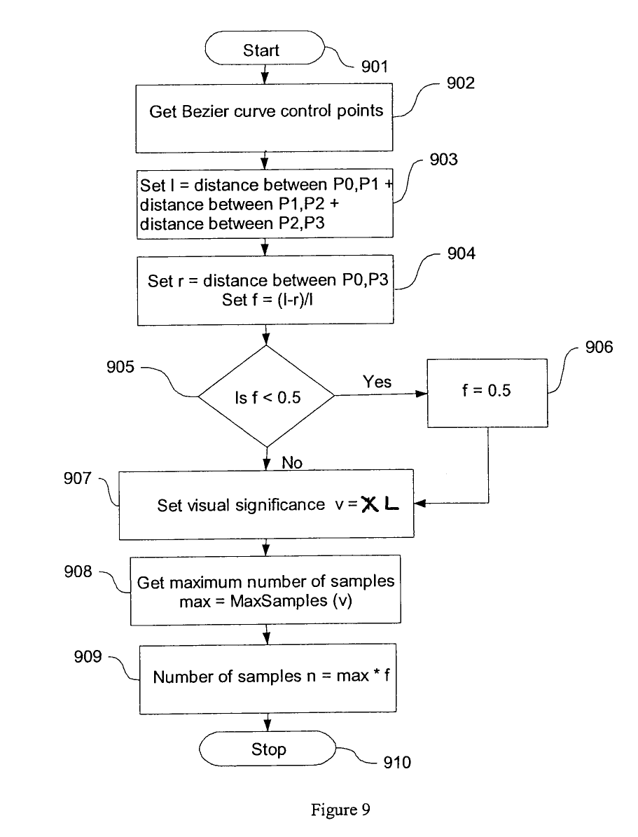

FIG. 9 describes the method for calculating the number of samples required for a curve that is defined by four control points. In the first step (902), the Bezier control points P0, P1, P2 and P3 are located. The perimeter of the quadrilateral (L) formed by the control points is calculated (903), which denotes the approximate length of the curve. Here, r is set as the distance between P0 and P3 (904), i.e., the distance between the start point and the end point of the curve. If a straight line is to be drawn between the two end points of the curve, approximately r pixels are required. The curvature estimation factor, f, is calculated using the following formula, f=(L−r)/L.

Here, f gives a good estimation of the curvature of the curve. The greater the value of f, the greater the curvature of the curve. For values of f lower than 0.5, the curve is more linear. The flattest curve is a straight line, and for a straight line, the curve estimation factor would be very close to zero. It is checked if f<0.5 (905). If f<0.5, then f is assigned a value of 0.5 (906). For a value of f≧0.5, the visual significance (v) is assigned to L, the perimeter of the curve (907). Depending on the application and the quality required by the user, the maximum number of samples for a range of perimeter values can be set. To set the maximum number of samples required for a particular perimeter value, the display area is divided into various ranges of perimeter values. For example, the ranges might be from 0-32, 33-256, 257-1024, 1025-4096, 4097-32768 and so on as shown in Table 2. Then, the maximum number of samples that should be taken for a particular range of perimeter values is decided.

TABLE 2

| v | max |
|---|---|
| 0-32 | 8 |
| 33-256 | 16 |
| 257-1024 | 24 |
| 1025-4096 | 32 |
| 4097-32768 | 48 |

This is a trial and error process and is similar to tuning a system to suit a certain specific purpose. Generally, the curves belonging to a higher range of v, i.e., curves having higher visual significance, will have more samples. Using the calculated value of v, the maximum number of samples (max) is obtained (908). The number of samples required for the curve can be obtained by multiplying the maximum number of samples (max) with the curvature estimation factor (f) (909).

In a second embodiment of the invention, the method considers the deviation error in calculating the number of samples required for defining the curve. The number of samples required or the step size for sampling is directly related to the deviation error present in the curve. By setting the maximum number of samples, the deviation error tolerable for a curve is set. The proposed method is also applicable to implementations which use deviation as a criterion for determining the step size. In such implementations, the concept of visual significance can be used to calculate the deviation. For curves with higher visual significance, the deviation is small as compared to the deviation for curves with lower visual significance.

For selecting the step size, a constant value of deviation is decided upon by experimentation, keeping in mind the desired quality. The relationship between the deviation and the step size is as follows:

e=h*h*|v×a|/(8*|v|)

where,
e=deviation
h=step size
v=magnitude of velocity vector of curve=|ds/dt|
a=magnitude of acceleration vector of curve=|dv/dt|

A constant value of deviation (decided by experimentation to obtain the required quality) and the velocity and acceleration vectors of the curve are used to select the step size.

The above invention has applications in low memory devices like cellular phones, PDAs, DVD players, car navigation systems etc.

A device according to an embodiment of the present invention may also include at least one computer readable medium or memory for holding instructions programmed according to the teachings of the invention and for containing data structures, tables, records, or other data described herein. Examples of computer readable media suitable for the present invention are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Such computer readable media further includes a computer program product of the present invention for performing the inventive method herein disclosed. The computer code devices of the present invention can be any interpreted or executable code mechanism, including but not limited to, scripts, interpreters, dynamic link libraries, Java classes, and complete executable programs.

Although the present invention has been described with particular reference to specific examples, variations and modifications of the present invention can be effected within the spirit and scope of the following claims.

What is claimed is:

1. A method to determine a number of samples used in rendering a Bezier curve, defined by first, second, third, and fourth sequential Bezier control points, the method comprising:
determining a visual significance of the curve by measuring a characteristic of the curve;
determining a curvature estimation factor of the curve based on a length of the curve and a distance between first and last control points of the curve; and
determining the number of samples for a predetermined accuracy depending on the visual significance of the curve and the curvature estimation factor.

2. The method according to claim 1, wherein the determining the visual significance of the curve includes,
determining a bounding box defined by the control points defining the Bezier curve, and
calculating an area of the bounding box as the visual significance.

3. The method according to claim 1, wherein the determining the visual significance of the curve includes,
calculating a perimeter of the curve (L) as a sum of distances given by:
a distance between a start point and the first control point,
a distance between the first control point and the second control point, and
a distance between the second control point and an end point; and
using the perimeter of the curve as the visual significance.

4. The method according to claim 1, wherein the determining the visual significance of the curve includes,
determining a background color,
determining a color of the curve,
comparing the background color with the color of the curve, and
determining the number of samples depending on a color contrast between the curve and the background.

5. The method according to claim 1, wherein the determining the curvature estimation factor of the curve includes,
calculating a perimeter of the curve (L) as a sum of the distances given by:
a distance between the first control point and the second control point,
a distance between the second control point and the third control point, and
a distance between the third control point and the fourth control point;
calculating a distance (r) between a start point and an end point; and
calculating the curvature estimation factor f by using f=(L−r)/L.

6. The method according to claim 1, wherein the determining the curvature estimation factor of the curve includes,
calculating a perimeter of the curve (L) as a sum of distances given by:
a distance between the first control point and the second control point,
a distance between the second control point and the third control point, and
a distance between the third control point and the fourth control point;
calculating a distance (r) between a start point and an end point;
calculating an intermediate curvature estimation factor e by using e=(L-r)/L; and
calculating the curvature estimation factor f depending on a tolerance t as f={x: x is the greater of e and t}.

7. The method according to claim 1, wherein the determining the curvature estimation factor includes setting the curvature estimation factor to a fixed value which depends on the predetermined accuracy.

8. The method according to claim 1, wherein the determining the number of samples includes:
determining a maximum number of samples based on the visual significance depending on the predetermined accuracy, and
determining the number of samples is determined by multiplying the maximum number of sample points by the curvature estimation factor.

9. The method according to claim 1, wherein the determining the number of samples includes using a predetermined mapping of visual significance ranges to a number of sample points.

10. A system configured to determine the number of samples used in rendering a Bezier curve, defined by first, second, third and fourth sequential Bezier control points, the system comprising:
a host processor;
an embedded memory;
a graphics processor unit (GPU), which includes a graphics controller configured to determine a visual significance of a curve by measuring a characteristic of the curve, a curvature estimation factor of the curve based on a length of the curve and a distance between first and last control points of the curve, and a number of samples for a predetermined accuracy depending on the visual significance of the curve and the curvature estimation factor;
an application programming interface (API); and
a PCI bus.

11. A system according to claim 10, wherein the embedded memory is one of a flash memory, a Read Only Memory (ROM), and a Random Access Memory (RAM).

12. The system according to claim 10, wherein the graphics controller is configured to determine the visual significance of the curve by determining a bounding box defined by the four control points defining the Bezier curve, and calculating an area of the bounding box as the visual significance.

13. The system according to claim 10, wherein the graphics controller is configured to determine the visual significance of the curve by,
calculating a perimeter of the curve (L) as a sum of distances given by:
a distance between a start point and the first control point,
a distance between the first control point and the second control point, and
a distance between the second control point and an end point, and
using the perimeter of the curve as the visual significance.

14. The system according to claim 10, wherein the graphics controller is configured to determine the visual significance of the curve by,
determining a background color,
determining a color of the curve,
comparing the background color with the color of the curve, and
determining the number of samples depending on a color contrast between the curve and the background.

15. The system according to claim 10, wherein the graphics controller is configured to determine the curvature estimation factor of the curve by,
calculating a perimeter of the curve (L) as the sum of the distances given by:
a distance between the first control point and the second control point,
a distance between the second control point and the third control point, and
a distance between the third control point and the fourth control point;
calculating a distance (r) between a start point and an end point; and
calculating the curvature estimation factor f by using f=(L−r)/L.

16. The system according to claim 10, wherein the graphics controller is configured to determine the curvature estimation factor of the curve by
calculating a perimeter of the curve (L) as a sum of distances given by:
a distance between the first control point and the second control point,
a distance between the second control point and the third control point, and
a distance between the third control point and the fourth control point;
calculating a distance (r) between a start point and an end point;
calculating an intermediate curvature estimation factor e by using e=(L−r)/L; and
calculating the curvature estimation factor f depending on a tolerance t as f={x: x is the greater of e and t}.

17. The system according to claim 10, wherein the graphics controller is configured to determine the curvature estimation factor by setting the curvature estimation factor to a fixed value which depends on the predetermined accuracy.

18. The system according to claim 10, wherein the graphics controller is configured to determine the number of samples by,
determining a maximum number of samples based on the visual significance depending on the predetermined accuracy, and
determining the number of samples by multiplying the maximum number of sample points by the curvature estimation factor.

19. The system according to claim 10, wherein the graphics controller is configured to determine the number of samples based on the visual significance using a predetermined mapping of visual significance ranges to a number of sample points.

20. A computer readable storage medium encoded with computer executable instructions, which when executed by a computer, cause the computer to perform a method to determine a number of samples used in rendering a Bezier curve, defined by first, second, third and fourth sequential Bezier control points, the method comprising:
determining a visual significance of a curve by measuring a characteristic of the curve;
determining a curvature estimation factor of the curve based on a length of the curve and a distance between first and last control points of the curve; and
determining the number of samples for a predetermined accuracy depending on the visual significance of the curve and the curvature estimation factor.
